(19) United States
(12) Patent Application Publication
(10) Pub. No.: US 2026/0351770 A1
(43) Pub. Date: Nov. 5, 2026

(54) MODULAR BATTERY ASSEMBLY, POWER DRIVE SYSTEM, AND GASOLINE-TO-ELECTRIC CONVERTED VEHICLE

(71) Applicant: REFINED MOTOR COMPANY LIMITED, HK (CN)

(72) Inventor: Ming Yau Angus Law, Hong Kong (CN)

(73) Assignee: REFINED MOTOR COMPANY LIMITED, HK (CN)

(21) Appl. No.: 19/721,103

(22) Filed: Jun. 26, 2026

(30) Foreign Application Priority Data
Apr. 28, 2025 (CN) 2025208214144

(51) Int. Cl. H01M 50/258; B60L 50/60; B60L 50/64; H01M 10/42; H01M 50/242; H01M 50/249; H01M 50/256; H01M 50/284; H01M 50/51; H01M 50/583

(52) U.S. Cl. CPC H01M 50/258; B60L 50/64; B60L 50/66; H01M 10/4207; H01M 10/425; H01M 50/242; H01M 50/249; H01M 50/256; H01M 50/284; H01M 50/51; H01M 50/583; H01M 2010/4271; H01M 2220/20

(57) ABSTRACT

The present disclosure provides a modular battery assembly, power drive system, and gasoline-to-electric converted vehicle. The modular battery assembly includes a support frame, a battery module, and a fixing assembly. The support frame is disposed on a vehicle body. The battery module comprises a plurality of battery boxes electrically connected in series end to end, and the plurality of battery boxes are disposed on the support frame along their longitudinal direction and/or transverse direction. The fixing assembly is disposed between the plurality of battery boxes and the vehicle body, and is located on the side of the battery module distal from the support frame, for fixing the battery boxes to the vehicle body.

### CROSS-REFERENCE TO RELATED APPLICATIONS

The application claims priority to Chinese patent application No. 2025208214144, filed on Apr. 28, 2025, the entire contents of which are incorporated herein by reference.

### TECHNICAL FIELD

The present disclosure relates to the technical field of gasoline-to-electric converted vehicles, and particularly relates to a modular battery assembly, power drive system, and gasoline-to-electric converted vehicle.

### BACKGROUND

Against the backdrop of increasingly prominent environmental protection demands and accelerated energy transition, conventional fuel-powered vehicles have encountered development constraints due to environmental pollution caused by exhaust emissions and the depletion of fossil energy resources. Meanwhile, electric vehicles have emerged as the prevailing trend in the automotive industry by virtue of their advantages of zero emissions, low noise, and high energy utilization efficiency. Gasoline-to-electric converted vehicles have thus come into being, which involve retrofitting conventional fuel-powered vehicles by replacing the fuel power system with an electric power system.

Chinese disclosure No. CN222432043U discloses a battery pack compatible support frame for a gasoline-to-electric converted vehicle, comprising a housing, in which a battery fixing mechanism is disposed; the battery fixing mechanism comprises two fixing frames located inside the housing; two push rods are fixedly connected to opposite side surfaces of the two fixing frames, respectively; opposite ends of the two sets of push rods extend through and beyond the housing; a push plate is fixedly connected to the distal end of each set of push rods; a threaded ring is fixedly embedded in the outer side surface of each push plate; threaded rods are rotatably connected to the left and right side surfaces of the housing, respectively, and each threaded rod is threadedly engaged with a corresponding threaded ring.

In existing gasoline-to-electric converted vehicles, the battery layout fails to fully utilize the space of the support frame, leading to a relatively low energy density of the battery module, making it difficult to accommodate more battery boxes within the limited vehicle body space, which limits the cruising range of the vehicle; moreover, the battery system lacks a modular design, rendering it incapable of flexibly adjusting the quantity and layout of batteries according to different vehicle body requirements and energy demands, thus failing to satisfy diversified market needs.

### SUMMARY

Accordingly, the present disclosure proposes a modular battery assembly, power drive system, and gasoline-to-electric converted vehicle, which is capable of fully utilizing support frame space, improving the energy density of the battery module, and increasing the cruising range without substantially increasing the size of the vehicle body; moreover, the battery boxes adopt a modular design to satisfy diverse market demands.

The technical solution of the present disclosure is realized as follows: In a first aspect, the present disclosure provides a modular battery assembly, comprising a support frame, a battery module, and a fixing assembly, wherein,
the support frame is disposed on a vehicle body;
the battery module comprises a plurality of battery boxes electrically connected in series end to end, and the plurality of battery boxes are disposed on the support frame along their longitudinal direction and/or transverse direction;
the fixing assembly is disposed between the plurality of battery boxes and the vehicle body, and is located on the side of the battery module distal from the support frame, for fixing the battery boxes to the vehicle body.

On the basis of the above technical solution, preferably, the support frame comprises a base mount, at least two support members, and a carrier plate, wherein,
the base mount is disposed on the vehicle body and is arranged parallel to the driving direction of the vehicle body;
the at least two support members are both disposed on the base mount, the at least two support members are arranged in parallel at intervals, and the cross-sectional shape of each support member is an isosceles trapezoid;
the carrier plate is disposed between the at least two support members and is located on the side distal from the base mount, for carrying the battery module (2).

On the basis of the above technical solution, preferably, the support frame further includes a plurality of reinforcing members, wherein, the carrier plate is hollowed out and has a polygonal cross-sectional shape, the plurality of reinforcing members are all disposed on both sides of the corners of the carrier plate and are arranged at equal intervals along the transverse direction of the support frame, for reinforcing the load-bearing capacity of the carrier plate.

On the basis of the above technical solution, preferably, the carrier plate comprises a first parallel segment, a connecting segment, and a second parallel segment, wherein,
the first parallel segment is fixed between the at least two support members on the side distal from the base mount, for installing the battery boxes arranged along the transverse direction;
the connecting segment is vertically fixed to the first parallel segment and is disposed on the side facing the base mount, and the plurality of reinforcing members are fixed between the first parallel segment and the connecting segment;
the second parallel segment is fixed to the connecting segment on the side distal from the first parallel segment, and is perpendicular to the connecting segment, for installing the battery boxes arranged along the longitudinal direction.

On the basis of the above technical solution, preferably, the fixing assembly comprises a plurality of angle braces and at least two first fixing members, wherein,
the plurality of angle braces are fixed by bolts at the corners of adjacent battery boxes, for fixing the battery boxes arranged along the transverse direction;
the at least two first fixing members are respectively fixed on the opposite outer side surfaces of the two outermost battery boxes arranged along the longitudinal direction, and the at least two first fixing members are also used in conjunction with the opposite outer side surfaces of the two outermost battery boxes arranged along the transverse direction, for fixing the battery module.

On the basis of the above technical solution, preferably, the fixing assembly further comprises at least two second fixing members and a load-bearing rod, wherein,

One end of each of the at least two second fixing members is respectively disposed on the opposite outer side surfaces of the outermost battery boxes arranged along the transverse direction, and the other end is fixedly connected to the load-bearing rod;
the load-bearing rod is spanning within the vehicle power compartment and is located on the side of the battery module distal from the support frame, for securing the position of the battery module.

On the basis of the above technical solution, preferably, a plurality of lifting rings are disposed on the side of each battery box distal from the support frame, and the lifting rings are used for hoisting the battery boxes into the vehicle power compartment.

In a second aspect, the present disclosure further provides a power drive system, comprising the modular battery assembly according to the first aspect, and further comprising a power distribution unit, a control module, an inverter, a charging module, and a drive module, wherein,
the high-voltage connection end of the battery module is electrically connected to one high-voltage connection end of the power distribution unit, and the other high-voltage connection end of the power distribution unit is electrically connected to one high-voltage connection end of the inverter, and the power distribution unit is used for controlling charging and discharging of the battery module;
the other high-voltage connection end of the inverter is electrically connected to the drive module and the charging module respectively, for performing current conversion to supply power to the drive module and charge the battery module;
the power distribution unit has a master battery management system (BMS), each battery box has a slave battery management system (BMS), all the slave BMS of the battery boxes are all communicatively connected to the master BMS, and the power distribution unit, the charging module, and the drive module are all communicatively connected to the control module, for monitoring system output signals.

On the basis of the above technical solution, preferably, the power distribution unit comprises an MSD fuse, a pre-charge resistor, a pre-charge relay, a main positive relay, a charging relay, a shunt, and a main negative relay, wherein,
the plurality of battery boxes are electrically connected in series end to end to form the battery module, the positive output end of the battery module is electrically connected to one end of the MSD fuse, the other end of the MSD fuse is electrically connected to the pre-charge resistor, one contact end of the main positive relay, and one contact end of the charging relay respectively, the other end of the pre-charge resistor is electrically connected to one contact end of the pre-charge relay, the other contact end of the pre-charge relay is electrically connected to the other contact end of the main positive relay and the main positive output end, and the other contact end of the charging relay is electrically connected to the charging positive input end; the negative output end of the battery module is electrically connected to the shunt, the other end of the shunt is electrically connected to one contact end of the main negative relay, and the other contact end of the main negative relay is electrically connected to a main negative output end and a charging negative input end respectively.

In a third aspect, the present disclosure further provides a gasoline-to-electric converted vehicle, comprising the power drive system according to the second aspect.

The modular battery assembly, power drive system, and gasoline-to-electric converted vehicle of the present disclosure has the following beneficial effects compared with the prior art:

(1) by disposing the plurality of battery boxes on the support frame along the longitudinal and/or transverse direction, the space of the support frame can be fully utilized, the energy density of the battery module can be increased, and the cruising range can be increased without substantially increasing the size of the vehicle body; the modular design allows for flexible adjustment of the quantity and layout of the battery boxes to meet diverse requirements, and the battery module can be installed or removed as a whole, such that battery replacement or maintenance can be accomplished simply by operating the fixing assembly, thereby significantly improving maintenance efficiency and reducing maintenance costs;

(2) by installing battery boxes with different arrangement directions on different segments of the carrier plate, the space of the support frame can be reasonably utilized, avoiding space wastage caused by a single arrangement mode of the battery boxes, so that more battery boxes can be accommodated in a limited space, the energy density of the battery module is increased, and the cruising range of the vehicle and other equipment is thereby improved;

(3) the lifting rings disposed on the battery boxes allow hoisting equipment to quickly and accurately lift and place the battery boxes into the vehicle power compartment, improving installation efficiency.

### BRIEF DESCRIPTION OF DRAWINGS

In order to explain the technical solutions in the embodiments of the present disclosure or in the prior art more clearly, the drawings used in the description of the embodiments or the prior art will be briefly introduced below. It is obvious that the drawings in the following description are only some embodiments of the present disclosure, and for those of ordinary skill in the art, other drawings can be obtained based on these drawings without any creative effort.

FIG. 1 is a perspective view of the modular battery assembly of the present disclosure;

FIG. 2 is a perspective view of the support frame of the modular battery assembly of the present disclosure;

FIG. 3 is a perspective view of the support frame of the modular battery assembly of the present disclosure from another perspective;

FIG. 4 is a schematic diagram of the connection between the battery module and the power distribution unit of the power drive system of the present disclosure;

FIG. 5 is a principle block diagram of the power drive system of the present disclosure;

FIG. 6 is a wiring circuit diagram of the power distribution unit and the battery module of the power drive system of the present disclosure;

FIG. 7 is a schematic installation diagram of the modular battery assembly of the gasoline-to-electric converted vehicle of the present disclosure;

FIG. 8 is a schematic installation diagram of the modular battery assembly of the gasoline-to-electric converted vehicle of the present disclosure from another perspective.

### DETAILED DESCRIPTION OF THE EMBODIMENTS

The technical solutions in the embodiments of the present disclosure will be clearly and completely described below in combination with the embodiments of the present disclosure. Obviously, the described embodiments are merely a part of the embodiments of the present disclosure, rather than all of the embodiments. Based on the embodiments of the present disclosure, all other embodiments obtained by those of ordinary skill in the art without creative labor shall fall within the protection scope of the present disclosure.

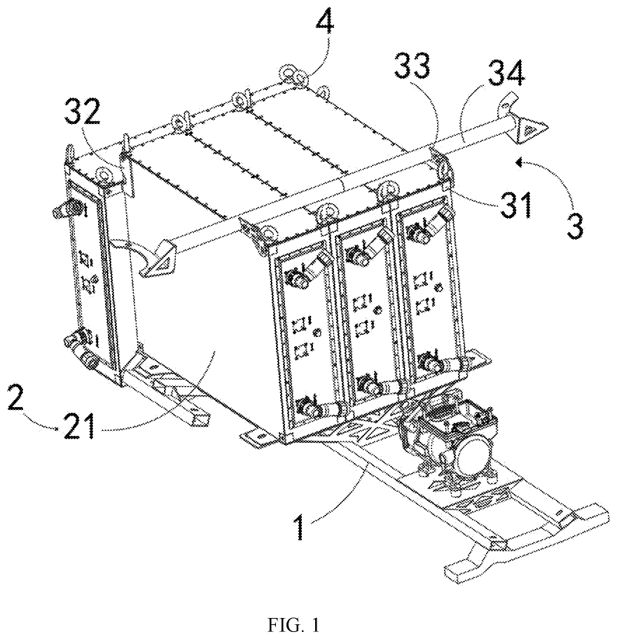

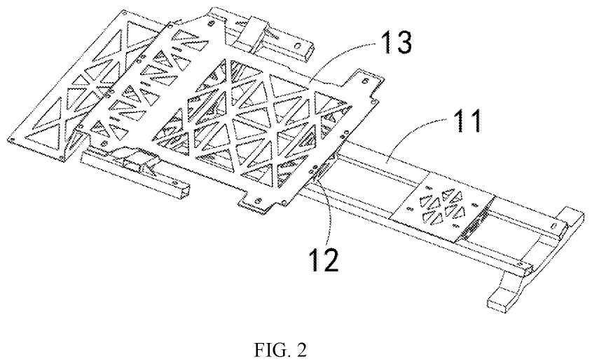

As shown in FIGS. 1-3, a modular battery assembly of the present disclosure comprises a support frame 1, a battery module 2, and a fixing assembly 3, wherein the support frame 1 is disposed on a vehicle body; the battery module 2 comprises a plurality of battery boxes 21 electrically connected in series end to end, and the plurality of battery boxes 21 are disposed on the support frame 1 along their longitudinal direction and/or transverse direction; the fixing assembly 3 is disposed between the plurality of battery boxes 21 and the vehicle body, and is located on the side of the battery module 2 distal from the support frame 1, for fixing the battery boxes 21 to the vehicle body.

It should be noted that, by disposing the plurality of battery boxes 21 on the support frame 1 along their longitudinal direction and/or transverse direction, this layout can fully utilize the space provided by the support frame 1, allowing the battery module 2 to achieve a higher energy density within the limited vehicle body space, so that the electric vehicle can accommodate more battery boxes 21 without substantially increasing the size of the vehicle body, thereby increasing the cruising range of the vehicle; furthermore, due to the modular design, the quantity and layout of the battery boxes 21 in the battery module 2 can be flexibly adjusted according to different vehicle body requirements and energy requirements to meet diverse market demands; meanwhile, the modular design allows the battery module 2 to be installed and removed as a whole; when it is necessary to replace the battery or perform maintenance, one only needs to operate the fixing assembly 3 to remove the battery module 2 from the support frame 1, without the need for complex operations on individual battery boxes 21, which greatly improves maintenance efficiency and reduces maintenance costs.

The support frame 1 in this embodiment comprises a base mount 11, at least two support members 12, and a carrier plate 13, wherein the base mount 11 is disposed on the vehicle body and is arranged parallel to the driving direction of the vehicle body; the at least two support members 12 are both disposed on the base mount 11, the at least two support members 12 are arranged in parallel at intervals, and the cross-sectional shape of each support member 12 is an isosceles trapezoid; the carrier plate 13 is disposed between the at least two support members 12 and is located on the side distal from the base mount 11, for carrying the battery module 2.

It should be noted that, the base mount 11 is fixed to the cross member of the vehicle body, providing a stable foundation for the entire support frame 1, which can effectively transfer the weight of the battery module 2 to the vehicle body, ensuring that the support frame 1 will not be displaced or deformed due to uneven force during vehicle driving; furthermore, the cross-sectional shape of the support members 12 is set to be an isosceles trapezoid, which can distribute the force more evenly onto the base mount 11 when subjected to pressure, avoiding local stress concentration and improving the load-bearing capacity and service life of the support members 12.

The support frame 1 in this embodiment further comprises a plurality of reinforcing members 14, wherein the carrier plate 13 is provided with hollow portions and has a polygonal-line cross-sectional shape, and the plurality of reinforcing members 14 are all disposed on both sides of the corners of the carrier plate 13 and are arranged at equal intervals along the transverse direction of the support frame 1, for reinforcing the load-bearing capacity of the carrier plate 13.

It should be noted that, the hollow design of the carrier plate 13 can reduce its own weight while ensuring a certain load-bearing capacity, which helps to reduce the weight of the entire battery assembly and improve the energy efficiency of the vehicle; the arrangement of the reinforcing members 14 can effectively resist deformation and damage caused by the weight of the battery module 2 and various forces generated during vehicle driving, improving the overall structural strength of the carrier plate 13; the plurality of reinforcing members 14 are arranged at equal intervals along the transverse direction of the support frame 1, which enables the carrier plate 13 to be effectively reinforced at different positions, avoiding situations where local strength is too high or too low, and ensuring the installation stability of the battery module 2.

The carrier plate 13 in this embodiment comprises a first parallel segment 131, a connecting segment 132, and a second parallel segment 133, wherein the first parallel segment 131 is fixed between the at least two support members 12 on the side distal from the base mount 11, for installing the battery boxes 21 arranged along the transverse direction; the connecting segment 132 is vertically fixed to the first parallel segment 131 and is disposed on the side facing the base mount 11, and the plurality of reinforcing members 14 are fixed between the first parallel segment 131 and the connecting segment 132; the second parallel segment 133 is fixed to the connecting segment 132 on the side distal from the first parallel segment 131, and is perpendicular to the connecting segment 132, for installing the battery boxes 21 arranged along the longitudinal direction.

It should be noted that, the segmented design of the carrier plate 13 can flexibly adapt to battery boxes 21 with different arrangement directions; the first parallel segment 131 is used for installing the battery boxes 21 arranged along the transverse direction, and the second parallel segment 133 is used for installing the battery boxes 21 arranged along the longitudinal direction, so that the support frame 1 can be adjusted according to the specific layout requirements of the battery module 2, which improves the versatility and applicability of the support frame 1 and can meet the installation requirements of battery modules with various different specifications and arrangement modes.

In this embodiment, by installing the battery boxes 21 with different arrangement directions on different segments of the carrier plate 13 respectively, the space of the support frame 1 can be utilized more reasonably, avoiding the space wastage problem caused by a single arrangement mode of the battery boxes 21, so that more battery boxes 21 can be accommodated in a limited space, the energy density of the battery module 2 is increased, and the cruising range of the vehicle and other equipment is thereby improved.

The fixing assembly 3 in this embodiment comprises a plurality of angle braces 31 and at least two first fixing members 32, wherein the plurality of angle braces 31 are fixed by bolts at the corners of adjacent battery boxes 21, for fixing the battery boxes 21 arranged along the transverse direction; the at least two first fixing members 32 are respectively fixed on the opposite outer side surfaces of the two outermost battery boxes 21 arranged along the longitudinal direction, and the at least two first fixing members 32 are also used in conjunction with the opposite outer side surfaces of the two outermost battery boxes 21 arranged along the transverse direction, for fixing the battery module 2.

It should be noted that, the plurality of angle braces 31 fixed by bolts at the corners of adjacent battery boxes 21 can constrain the battery boxes 21 arranged along the transverse direction from multiple angles, effectively preventing relative displacement of the battery boxes 21 in the horizontal and vertical directions, and ensuring the connection stability and integrity between the battery boxes 21; the at least two first fixing members 32 are respectively fixed on the opposite outer side surfaces of the two outermost battery boxes 21 arranged along the longitudinal direction, as well as on the opposite outer side surfaces of the two outermost battery boxes 21 arranged along the transverse direction, which can fix the battery module 2 from multiple directions, further enhancing the stability of the battery module 2 on the vehicle body and preventing it from loosening or falling off due to factors such as vibration and impact during vehicle driving.

In this embodiment, the provision of the angle braces 31 and the first fixing members 32 not only serves to fix the battery boxes 21 and enhance the overall structural strength of the battery module 2, but also allows the battery boxes 21 to be connected as a whole to jointly withstand various forces and vibrations during vehicle driving, thereby improving the deformation resistance and reliability of the battery module 2.

The fixing assembly 3 in this embodiment further comprises at least two second fixing members 33 and a load-bearing rod 34, wherein one end of each of the at least two second fixing members 33 is respectively disposed on the opposite outer side surfaces of the two outermost battery boxes 21 arranged along the transverse direction, and the other end is fixedly connected to the load-bearing rod 34; the load-bearing rod 34 is spanning the vehicle power compartment and is located on the side of the battery module 2 opposite the support frame 1, for securing the position of the battery module 2.

It should be noted that one end of each of the at least two second fixing members 33 is respectively disposed on the opposite outer side surfaces of the two outermost battery boxes 21 arranged along the transverse direction, and the other end is fixedly connected to the load-bearing rod 34, so that the battery module 2 obtains additional fixed support in the transverse direction, further limiting the displacement of the battery module 2 in the horizontal direction and enhancing the overall fixing stability of the battery module 2; the load-bearing rod 34 is spanning the vehicle power compartment, providing a stable support base for the second fixing members 33, which enables the second fixing members 33 to more effectively transmit the force of the battery module 2 to the vehicle body, ensuring the reliable fixation of the battery module 2 by the fixing assembly 3.

In this embodiment, a plurality of lifting rings 4 are disposed on the side of each battery box 21 distal from the support frame 1, and the lifting rings 4 are used for hoisting the battery boxes 21 into the vehicle power compartment.

It should be noted that the plurality of lifting rings 4 provide clear hoisting points for the hoisting equipment; when hoisting the battery boxes 21 into the vehicle power compartment, the hooks of the hoisting equipment can be directly hooked onto the lifting rings 4, making the operation simple and convenient, enabling the battery boxes 21 to be quickly and accurately lifted and placed into the vehicle power compartment, thereby improving installation efficiency.

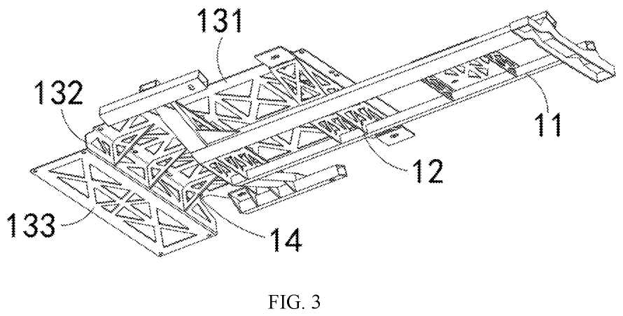

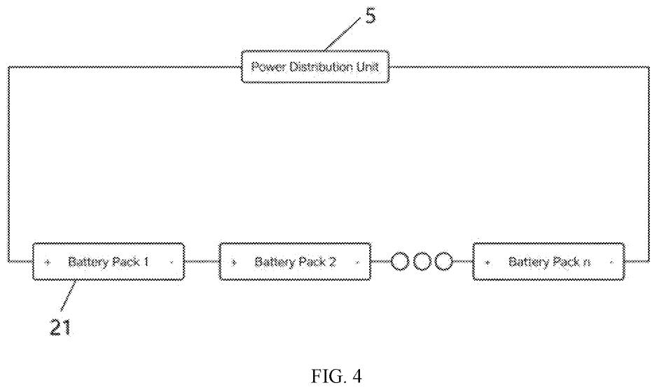

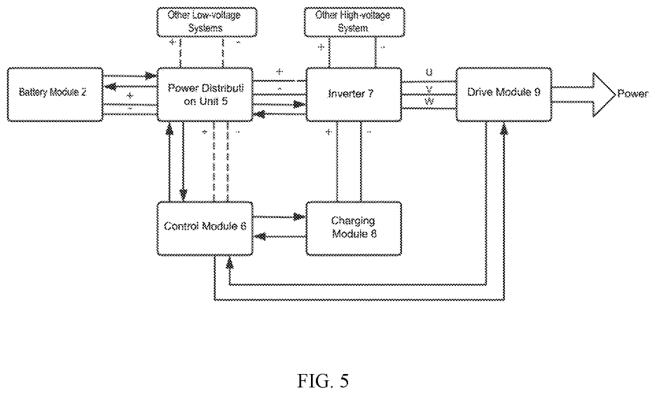

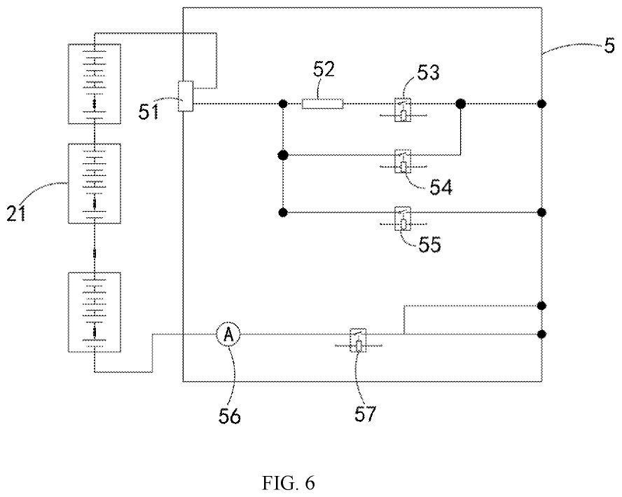

As shown in FIGS. 3-6, in a second aspect, the present disclosure also provides a power drive system, comprising a modular battery assembly, and further comprising a power distribution unit 5, a control module 6, an inverter 7, a charging module 8, and a drive module 9, wherein a high-voltage connection end of the battery module 2 is electrically connected to one end of a high-voltage connection end of the power distribution unit 5, the other end of the high-voltage connection end of the power distribution unit 5 is electrically connected to one end of a high-voltage connection end of the inverter 7, and the power distribution unit 5 is used for controlling charging and discharging of the battery module 2; the other high-voltage connection end of the inverter 7 is electrically connected to the drive module 9 and the charging module 8 respectively, for performing current conversion to supply power to the drive module 9 and charge the battery module 2; the power distribution unit 5 has a master battery management system (BMS), each battery box 21 has a slave battery management system (BMS), all the slave BMS of the battery boxes 21 are all communicatively connected to the master BMS, and the power distribution unit 5, the charging module 8, and the drive module 9 are all communicatively connected to the control module 6, for monitoring system output signals.

Specifically, the drive module 9 is a three-phase motor, and a low-voltage connection end of the power distribution unit 5 is electrically connected to other low-voltage systems in the vehicle and the control module 6 respectively, for low-voltage power supply.

It should be noted that the modular battery assembly serves as the energy storage unit of the system to provide electric energy for the entire power drive system, and a high-voltage connection end of the battery module 2 is electrically connected to one end of a high-voltage connection end of the power distribution unit 5 to realize the transmission of electric energy. All the slave BMS of the battery boxes 21 are communicatively connected to the master BMS of the power distribution unit 5, which facilitates the unified management and monitoring of the battery boxes 21 by the master BMS; The power distribution unit 5 precisely controls the charging and discharging process of the battery module 2 to ensure safe and efficient use of the battery; the power distribution unit 5 has a master BMS, which is communicatively connected to all the slave BMS of the battery boxes 21 to obtain state information of the battery boxes 21 in real time, such as voltage, current, temperature, etc., and adjusts charging and discharging strategies based on this information to distribute the electric energy provided by the battery module 2 to the inverter 7, thereby providing suitable electric energy to the drive module 9 and the charging module 8; furthermore, the power distribution unit 5 is communicatively connected to the control module 6 to transmit battery status and charging/discharging control information to the control module 6; the control module 6, as the control center of the system, receives output signals from the power distribution unit 5, the charging module 8, and the drive module 9, and monitors and manages the entire power drive system; based on the received information, it coordinates the work of all components to ensure the stable operation of the system; the inverter 7 converts the direct current provided by the power distribution unit 5 into alternating current to meet the power supply requirements of the drive module 9 and charge the battery module 2, and converts the alternating current generated by the three-phase motor during deceleration into direct current to charge the battery module 2; the drive module 9 converts the alternating current provided by the inverter 7 into mechanical energy to drive the vehicle and other equipment.

The working process is as follows: the control module 6 sends a start command, and the power distribution unit 5 determines whether the state of the battery module 2 is suitable for starting based on the information from the master BMS and each slave BMS; if the state is normal, the power distribution unit 5 allows the battery module 2 to supply power to the inverter 7, and the inverter 7 converts the direct current into alternating current to provide electric energy for the drive module 9, driving the vehicle to start; The control module 6 continuously monitors the output signals of the power distribution unit 5, the charging module 8, and the drive module 9, and adjusts the working parameters of each component according to the vehicle driving state and the battery state; The power distribution unit 5 reasonably controls the discharge current of the battery module 2 according to the instructions of the master BMS to ensure safe operation of the battery; when the vehicle needs to be charged, the control module 6 sends a charging command, and the charging module 8 acquires electric energy through the inverter 7 to charge the battery module 2; the power distribution unit 5 and the master BMS monitor the charging process to ensure that parameters such as charging current and voltage are within safe ranges.

It can be understood that the modular battery assembly facilitates the maintenance, replacement, and upgrading of the battery, and improves the flexibility and scalability of the system; in addition, the communicative connection between the master BMS and the slave BMS realizes refined management of the battery module, improving the service efficiency and safety of the battery.

In this embodiment, the power distribution unit 5 includes an MSD fuse 51, a pre-charge resistor 52, a pre-charge relay 53, a main positive relay 54, a charging relay 55, a shunt 56, and a main negative relay 57, wherein the plurality of battery boxes 21 are electrically connected in series end to end to form the battery module 2, a positive output end of the battery module 2 is electrically connected to one end of the MSD fuse 51, the other end of the MSD fuse 51 is electrically connected to the pre-charge resistor 52, one contact end of the main positive relay 54, and one contact end of the charging relay 55 respectively, the other end of the pre-charge resistor 52 is electrically connected to one contact end of the pre-charge relay 53, the other contact end of the pre-charge relay 53 is electrically connected to the other contact end of the main positive relay 54 and the main positive output end, and the other contact end of the charging relay 55 is electrically connected to a charging positive input end; a negative output end of the battery module 2 is electrically connected to the shunt 56, the other end of the shunt 56 is electrically connected to one contact end of the main negative relay 57, and the other contact end of the main negative relay 57 is electrically connected to a main negative output end and a charging negative input end, respectively.

The workflow is as follows: when the system starts, the control module 6 issues a pre-charge command, the pre-charge relay 53 closes, and the main positive relay 54 and the charging relay 55 remain disconnected. The positive electrical energy of the battery module 2 slowly charges subsequent components such as capacitors through the MSD fuse 51, the pre-charge resistor 52, and the pre-charge relay 53; the shunt 56 monitors the output current of the battery module 2 in real time and feeds back a current signal to the control module 6; when the capacitor is charged to a certain extent, the control module 6 issues a command, the pre-charge relay 53 disconnects, and the main positive relay 54 closes, at which point the positive electrical energy of the battery module 2 is transmitted to the main positive output end through the MSD fuse 51 and the main positive relay 54 to power components such as the inverter 7; the main negative relay 57 is always in a closed state, ensuring that the negative electrode of the battery module 2 is in connection with the main negative output end and the charging negative input end; when the vehicle needs to be charged, the control module 6 issues a charging command, the charging relay 55 closes, the positive electrode of the charging power source is connected to the positive electrode of the battery module 2 through the charging positive input end and the charging relay 55, and the negative electrode of the charging power source is connected to the negative electrode of the battery module 2 through the charging negative input end and the main negative relay 57 to achieve charging of the battery module 2, and the shunt 56 continues to monitor the charging current and feeds back current information to the control module 6, so that the control module 6 can adjust charging parameters.

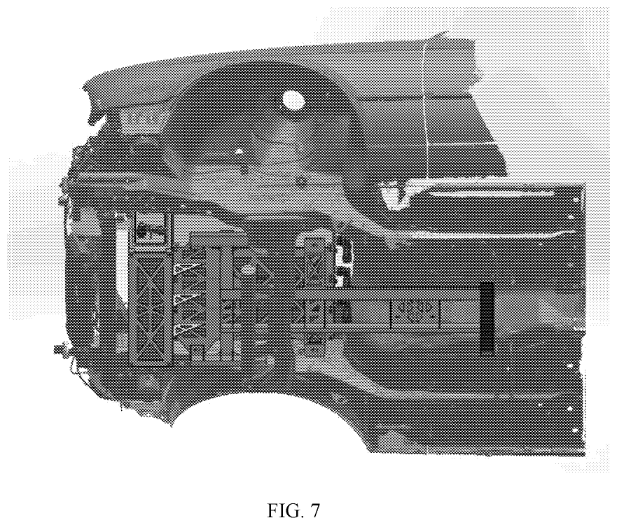

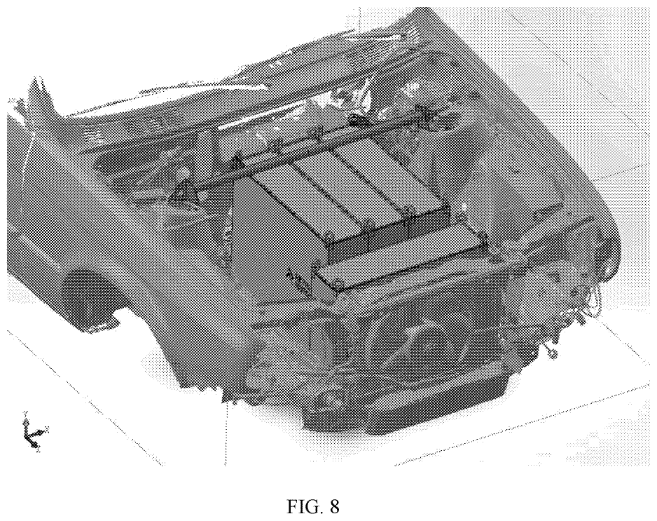

As shown in FIGS. 7-8, in a third aspect, the present disclosure further provides a gasoline-to-electric converted vehicle, comprising a power drive system.

The above descriptions are only preferred embodiments of the disclosure and are not intended to limit the disclosure. Any modifications, equivalent substitutions, improvements, etc., made within the spirit and principles of the disclosure shall be included within the protection scope of the disclosure.

What is claimed is:

1. A modular battery assembly, characterized in that it comprises a support frame (1), a battery module (2) and a fixing assembly (3), wherein,
the support frame (1) is disposed on a vehicle body;
the battery module (2) comprises a plurality of battery boxes (21) electrically connected in series end to end, and the plurality of battery boxes (21) are disposed on the support frame (1) along their longitudinal direction and/or transverse direction;
the fixing assembly (3) is disposed between the plurality of battery boxes (21) and the vehicle body, and is located on the side of the battery module (2) distal from the support frame (1), for fixing the battery boxes (21) to the vehicle body.

2. The modular battery assembly according to claim 1, characterized in that the support frame (1) comprises a base mount (11), at least two support members (12), and a carrier plate (13), wherein,
the base mount (11) is disposed on the vehicle body and is arranged parallel to the driving direction of the vehicle body;
the at least two support members (12) are both disposed on the base mount (11), the at least two support members (12) are arranged in parallel at intervals, and the cross-sectional shape of each support member (12) is an isosceles trapezoid;
the carrier plate (13) is disposed between the at least two support members (12) and is located on the side distal from the base mount (11), for carrying the battery module (2).

3. The modular battery assembly according to claim 2, characterized in that the support frame (1) further comprises a plurality of reinforcing members (14), wherein the carrier plate (13) is provided with hollow portions and has a polygonal-line cross-sectional shape, and the plurality of reinforcing members (14) are all disposed on both sides of the corners of the carrier plate (13) and are arranged at equal intervals along the transverse direction of the support frame (1), for reinforcing the load-bearing capacity of the carrier plate (13).

4. The modular battery assembly according to claim 3, characterized in that the carrier plate (13) comprises a first parallel segment (131), a connecting segment (132) and a second parallel segment (133), wherein,
the first parallel segment (131) is fixed between the at least two support members (12) on the side distal from the base mount (11), for installing the battery boxes (21) arranged along the transverse direction;
the connecting segment (132) is vertically fixed to the first parallel segment (131) and is disposed on the side facing the base mount (11), and the plurality of reinforcing members (14) are fixed between the first parallel segment (131) and the connecting segment (132);
the second parallel segment (133) is fixed to the connecting segment (132) on the side distal from the first parallel segment (131), and is perpendicular to the connecting segment (132), for installing the battery boxes (21) arranged along the longitudinal direction.

5. The modular battery assembly according to claim 1, characterized in that the fixing assembly (3) comprises a plurality of angle braces (31) and at least two first fixing members (32), wherein,
the plurality of angle braces (31) are fixed by bolts at the corners of adjacent battery boxes (21), for fixing the battery boxes (21) arranged along the transverse direction;
The at least two first fixing members (32) are respectively fixed on the opposite outer side surfaces of the two outermost battery boxes (21) arranged along the longitudinal direction, and the at least two first fixing members (32) are also used in conjunction with the opposite outer side surfaces of the two outermost battery boxes (21) arranged along the transverse direction, for fixing the battery module (2).

6. The modular battery assembly according to claim 5, characterized in that the fixing assembly (3) further comprises at least two second fixing members (33) and a load-bearing rod (34), wherein,
one end of each of the at least two second fixing members (33) is respectively disposed on the opposite outer side surfaces of the two outermost battery boxes (21) arranged along the transverse direction, and the other end is fixed to the load-bearing rod (34);
the load-bearing rod (34) is spanning within the vehicle power compartment and is located on the side of the battery module (2) distal from the support frame (1), for securing the position of the battery module (2).

7. The modular battery assembly according to claim 1, characterized in that a plurality of lifting rings (4) are disposed on the side of each battery box (21) distal from the support frame (1), and the lifting rings (4) are used for hoisting the battery boxes (21) into the vehicle power compartment.

8. A power drive system, characterized in that it comprises the modular battery assembly according to claim 1, and further comprises a power distribution unit (5), a control module (6), an inverter (7), a charging module (8), and a drive module (9), wherein,
the high-voltage connection end of the battery module (2) is electrically connected to one high-voltage connection end of the power distribution unit (5), and the other high-voltage connection end of the power distribution unit (5) is electrically connected to one high-voltage connection end of the inverter (7), and the power distribution unit (5) is used for controlling charging and discharging of the battery module (2);
the other high-voltage connection end of the inverter (7) is electrically connected to the drive module (9) and the charging module (8) respectively, for performing current conversion to supply power to the drive module (9) and charge the battery module (2);
the power distribution unit (5) has a master battery management system (BMS), each battery box

(21) has a slave battery management system (BMS), all the slave BMS of the battery boxes (21) are all communicatively connected to the master BMS, and the power distribution unit (5), the charging module (8), and the drive module (9) are all communicatively connected to the control module (6), for monitoring system output signals.

9. The power drive system according to claim 8, characterized in that the power distribution unit (5) comprises an MSD fuse (51), a pre-charge resistor (52), a pre-charge relay (53), a main positive relay (54), a charging relay (55), a shunt (56), and a main negative relay (57), wherein,
the plurality of battery boxes (21) are electrically connected in series end to end to form the battery module (2), the positive output end of the battery module (2) is electrically connected to one end of the MSD fuse (51), the other end of the MSD fuse (51) is electrically connected to the pre-charge resistor (52), one contact end of the main positive relay (54), and one contact end of the charging relay (55) respectively, the other end of the pre-charge resistor (52) is electrically connected to one contact end of the pre-charge relay (53), the other contact end of the pre-charge relay (53) is electrically connected to the other contact end of the main positive relay (54) and the main positive output end, and the other contact end of the charging relay (55) is electrically connected to the charging positive input end; the negative output end of the battery module (2) is electrically connected to the shunt (56), the other end of the shunt (56) is electrically connected to one contact end of the main negative relay (57), and the other contact end of the main negative relay (57) is electrically connected to a main negative output end and a charging negative input end respectively.

10. A gasoline-to-electric converted vehicle, characterized in that it comprises the power drive system according to claim 8.
